(19) United States
(12) Patent Application Publication
(10) Pub. No.: US 2003/0107577 A1
(43) Pub. Date: Jun. 12, 2003

(54) DATA PROCESSING SYSTEM HAVING A PLURALITY OF PROCESSORS AND EXECUTING A SERIES OF PROCESSINGS IN A PRESCRIBED ORDER

(76) Inventors: MITSURU OBARA, TOYOHASHI-SHI (JP); KENICHI SAWADA, TOYOHASHI-SHI (JP); ATSUSHI ISHIKAWA, OKAZAKI-SHI (JP); KAZUHIRO ISHIGURO, TOYOHASHI-SHI (JP)

Correspondence Address: BURNS DOANE SWECKER & MATHIS L L P, POST OFFICE BOX 1404, ALEXANDRIA, VA, 22313-1404, US

(21) Appl. No.: 09/427,114

(22) Filed: Oct. 26, 1999

(30) Foreign Application Priority Data
Oct. 30, 1998 (JP) 10-311381

(51) Int. Cl. G06T 1/20

(52) U.S. Cl. 345/506

(57) ABSTRACT

A data processing system has the following construction in order to reduce the memory capacity and the cost. There are provided a plurality of processors to execute to input image data a series of processings including Log conversion, MTF correction, gamma correction and binarization in a prescribed order and a memory to store pixel data to be processed and a state flag to represent the state of processing the pixel data in association with each other. Processings by the plurality of processors are executed asynchronously. The plurality of processors share the memory.

This application is based on application No. 10-311381 filed in Japan, the content of which is hereby incorporated by reference.

### BACKGROUND OF THE INVENTION

1. Field of the Invention

The present invention relates generally to a data processing system, and more particularly, to a data processing system executing a plurality of processings in a prescribed order using a plurality of processors.

2. Description of the Related Art

Referring to FIG. 18, a conventional data processing apparatus includes an MPU 1, an image input device 2, processing portions 3 to 6 to execute four processings, Log conversion, MTF correction, gamma correction and binarization, and an image output device 7.

Image input device 2 includes a photoelectric conversion element such as CCD, a driving system therefor, and an A/D converter, scans a document including both a continuous tone image and line drawing to generate a sampling analog signal, and quantize the sampling analog signal into continuous tone reflectivity data, in which each pixel has 8 bits (256 tones), for output as a digital signal.

Processing portion 3 performs Log conversion. By the Log conversion, 8-bit continuous tone density data in the Log relation with the continuous tone reflectivity data output from image input device 2 is calculated.

Processing portion 4 performs MTF correction processing. The MTF correction processing is performed to correct sharpness, and the sharpness of the 8-bit continuous tone density data obtained by the Log conversion at processing portion 3 is corrected using a digital filter such as Laplacian filter.

Processing portion 5 performs gamma correction processing. The gamma correction processing is performed to correct the difference in the tone curve between image input device 2 and image output device 7 so as to realize a desired gamma characteristic for the entire data processing apparatus. For example, using an LUT (Look Up Table) of 256 words, 8 bits, non-linear gamma correction data is output. The gamma correction may be also performed to set a desired gamma characteristic for the operator.

Processing portion 6 performs binarizing processing. The binarizing processing is performed to convert 8-bit continuous tone density data subjected to the gamma correction into 1-bit binary data corresponding to the brightness. The binarizing processing employs area-type tone binarizing such as error diffusion binarizing.

Image output device 7 is a printer such as an electrophotographic printer or ink jet printer, and prints the 1-bit binary data formed by binarization at processing portion 6 onto an output medium such as paper.

In the conventional data processing apparatus, image data input from image input device 2 is sequentially processed by processing portions 3 to 6 on a one pixel data piece basis. In order to achieve synchronism in exchange of the pixel data among image input device 2, processing portions 3 to 6, and image output device 7, a pixel clock corresponding to each piece of pixel data is generated by a clock generator (not shown), and image input device 2, processing portions 3 to 6, and image output device 7 operate in synchronization with a pixel clock.

Since the conventional data processing apparatus allows image input device 2, processing portions 3 to 6, and image output device 7 to operate in synchronization, the pixel clock must be generated based on any element having the lowest operating speed among image input device 2, processing portions 3 to 6, and image output device 7. As a result, the circuit must be constructed according to a processing portion forming a bottleneck, which makes difficult the circuit design.

In order to solve this program, a circuit configuration in which image input device 2, processing portions 3 to 6 and image output device 7 are connected in asynchronous manner so as to be operated in response to independent clocks may be considered. FIG. 19 is a block diagram for explaining a circuit configuration in which processing blocks are connected in asynchronous manner. Referring to FIG. 19, processing blocks A, B and C can operate to perform processing in response to clock signals specific to them.

In this case, however, data cannot be directly exchanged among the processing blocks, and therefore buffer memories having a prescribed capacity should be provided among the blocks. Such a buffer memory can absorb the difference in the processing speeds of the processing blocks.

Thus, if the processing blocks are connected in an asynchronous manner, a processing portion forming a bottleneck would not determine the processing speed of the data processing device unlike the case of connecting image output device 2, processing portions 3 to 6 and image output device 7 to operate in synchronization with one another as shown in FIG. 18. Meanwhile, the buffer memories are necessary, which push up the cost. In addition, since data is written/read to/from the two processing blocks, each block must accommodate such that one of the blocks access a buffer memory, or such an arbitration processing must be performed by a controller provided for each of the buffer memories.

The present invention was made in view of the above, and it is one object of the present invention to provide a data processing system capable of processing data at a high speed. Another object of the present invention is to provide a data processing system which permits the memory capacity used to be reduced.

### SUMMARY OF THE INVENTION

In order to achieve the above-described objects, a data processing system according to one aspect of the present invention includes a plurality of processors which execute a series of processings to data to be processed in a prescribed order, and a memory which stores data and state information representing the state of processing the data in association with one another, and the processings executed by the plurality of processors are asynchronously executed, and the plurality of processors share the memory.

According to the present invention, a data processing apparatus capable of processing data at a high speed can be provided. Furthermore, a data system which permits data to be processed with a reduced memory capacity can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the general configuration of a data processing apparatus according to a first embodiment of the present invention;

FIG. 2 is a diagram showing a format for pixel data according to the first embodiment;

FIG. 3 is a table of state flags used in the data processing apparatus according to the first embodiment;

FIG. 4 is a diagram for use in illustration of the memory capacity of a memory;

FIGS. 5A to 5F are diagrams for use in illustration of change with time in data stored in the memory;

FIG. 6 is a flow chart for use in illustration of the flow of processing executed in processing portions;

FIGS. 7A and 7B are diagrams for use in illustration of pixel data used for MTF correction process;

FIG. 8 is a diagram showing another format for pixel data stored in the memory;

FIG. 9 is a block diagram showing the general configuration of a data processing apparatus according to a second embodiment of the present invention;

FIG. 10 is a flow chart for use in illustration of the flow of state control processing executed at a state control portion according to the second embodiment;

FIG. 11 is a flow chart for use in illustration of processing executed by processing portions according to the second embodiment;

FIG. 12 is a block diagram showing the general configuration of a data processing apparatus according to a third embodiment of the present invention;

FIG. 13 is a flow chart for use in illustration of the flow of region determining processing executed in a region determining portion according to the third embodiment;

FIG. 14 is a table of state flags used in a data processing apparatus according to the third embodiment;

FIG. 15 is a block diagram showing the general configuration of a data processing apparatus according to a fourth embodiment of the present invention;

FIG. 16 is a diagram showing a format for pixel data stored in a memory according to the fourth embodiment;

FIG. 17 is a table of state flags used in the data processing apparatus according to the fourth embodiment;

FIG. 18 is a block diagram showing the general configuration of a synchronous data processing apparatus; and

FIG. 19 is a block diagram for use in illustration of asynchronous processings executed at a plurality of processing blocks.

### DESCRIPTION OF THE PREFERRED EMBODIMENTS

Embodiments of the present invention will be now described in conjunction with the accompanying drawings, in which the same reference characters refer to the same or corresponding portions.

First Embodiment

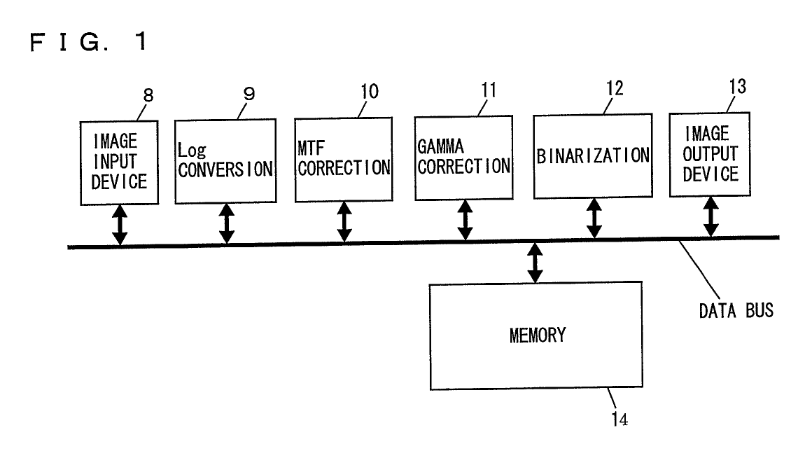

Referring to FIG. 1, the data processing apparatus includes an image input device 8 to input image data, processing portions 9 to 12 to perform various processings for each pixel data of the input image data, an image output device 13 formed of an electrophotographic printer or inkjet printer to output the processed image data onto a recording medium such as paper, and a memory 14.

Processing portion 9 performs Log conversion processing for each of the pixel data of the image data input by image input device 8. Processing portion 10 performs MTF correction to data after the Log conversion at processing portion 9. Processing portion 11 performs gamma correction to the data after the MTF correction at processing portion 10. Processing portion 12 binarizes the data after the gamma correction at processing portion 11. The four processings, the Log conversion, MTF correction, gamma correction and binarizing are the same as those previously described. The input processing by the image input device and the output processing by the image output device are the same as those performed by image input device 2 and image output device 7 described above and therefore the description is not repeated.

Image input device 8, processing portions 9 to 12, and image output device 13 (hereinafter referred to “processing portions 8 to 13”) are connected to memory 14 through a data bus, and each of processing portions 8 to 13 writes/reads data to/from memory 14 through the data bus. Memory 14 is a common memory to/from which processing portions 8 to 13 can write/read data. Memory 14 also has a controller (not shown) so that any one of processing portions 8 to 13 can read or write data.

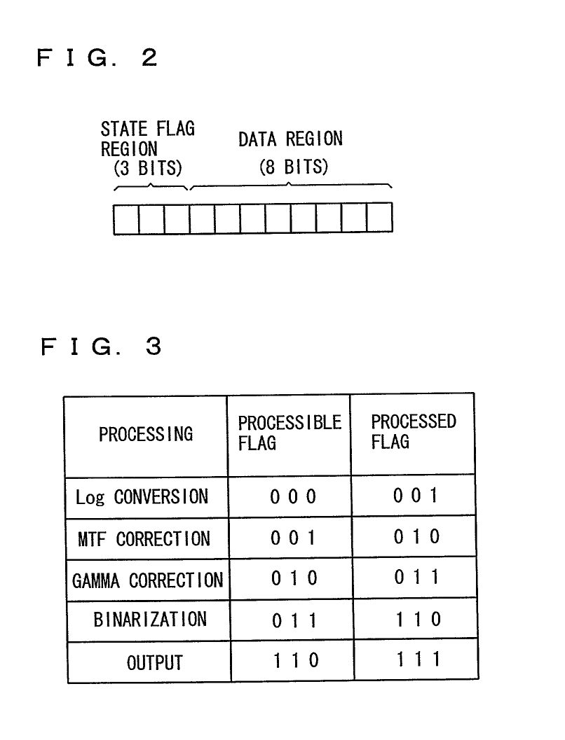

The data format of image data stored in memory 14 will be now described. Image data consists of a set of a plurality of pieces of pixel data. Referring to FIG. 2, pixel data is stored in a format formed of a 3-bit state flag region and a 8-bit data region. The state flag regions and data regions as many as the number of pieces of pixel data will be stored in memory 14.

The state flag region consists of three bits, because there are six processing portions 8 to 13. The region may be formed of bits more or less than three depending on the number of processing portions. The data region consists of 8 bits, because the pixel data is represented in 256 tones. The data region is however not limited to the 8-bit region, and the bit number may be changed depending upon the size of the pixel data.

The state flag will be now described. The state flag represents up to which processing by processing portions 8 to 13 the pixel data has been through, in other words the flag represents which processing is to be performed next. FIG. 3 is a table for use in illustration of the state flag. The state flag is represented by a 3-digit binary number, in other words by 3 bits. If the state flag is “000”, the flag represents that the pixel data stored in the data region is data input by image input device 8 and data which can be subjected to Log conversion by processing portion 9. If the state flag is “001”, the flag represents that the pixel data stored in the data region has been subjected to Log conversion, and can be subjected to MTF correction at processing portion 10. Similarly if the state flag is “010”, the data has been subjected to MTF correction and can be subjected to gamma correction. If the state flag is “011”, the data has been subjected to gamma correction and can be binarized. If the state flag is “110”, the data has been binarized and can has its image output. If the state flag is “111”, the data has its image output.

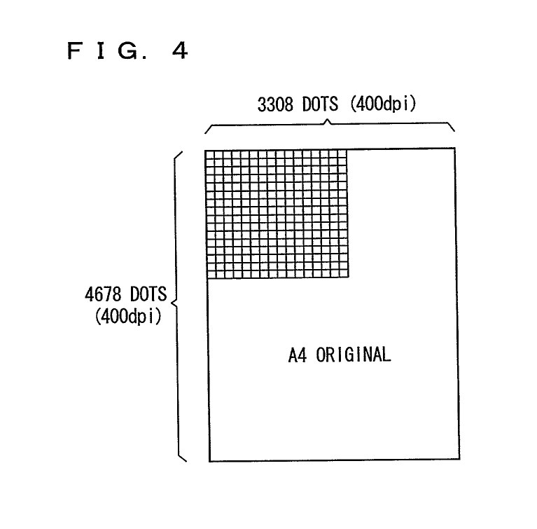

Referring to FIG. 4, a necessary memory capacity for memory 14 will be described. If for example, the size of image data input by image input device 8 is the A4 sheet size, and the pixel density is 400 dpi, the number of pixels necessary is 3308 dots in the horizontal direction, and 4678 dots in the vertical direction. Image data for one pixel is 11 bits as shown FIG. 2, and therefore the memory capacity necessary for memory 14 is 3308×4678×11 bits.

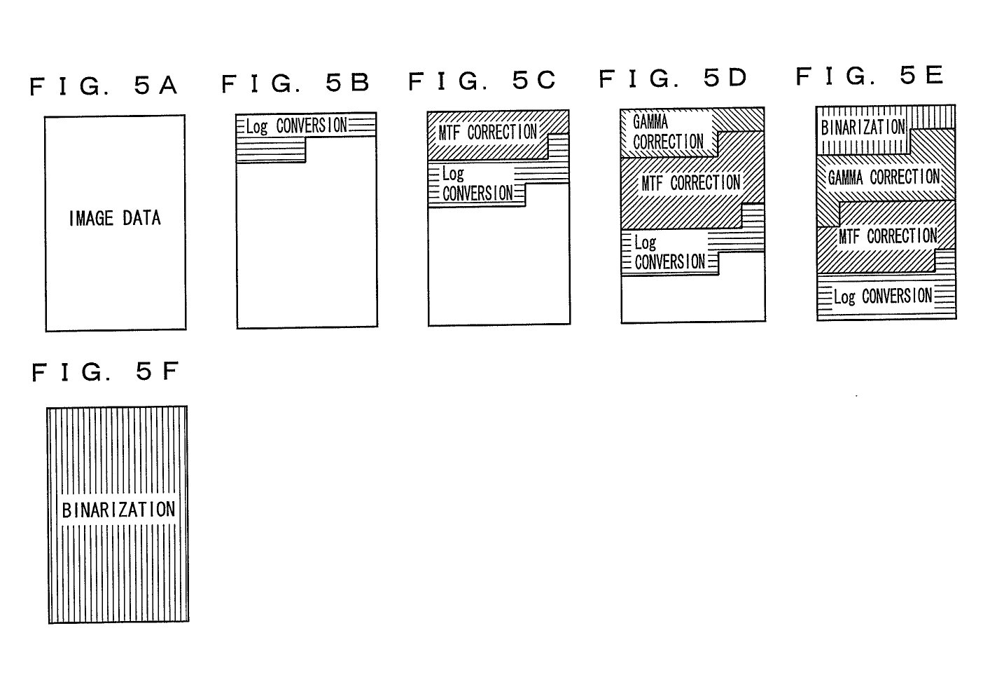

The state of image data stored in memory 14 will be now described. FIG. 5A shows that image data has been input by image input device 8 and stored in memory 14. The flag regions of the pixel data pieces in this state are all stored as “000”. FIG. 5B shows that part of the image data stored in memory 14 has been subjected to Log conversion processing at processing portion 9. The flag state region of pixel data subjected to the Log conversion has been changed to “001”and stored. FIG. 5C shows that part of the image data stored in memory 14 has been subjected to MTF correction at processing portion 10. The state flag regions of pixel data pieces which have been subjected to the MTF correction are stored as “010”. FIG. 5D shows that part of the image data stored in memory 14 has been subjected to gamma correction at processing portion 11. The state flag regions of the pixel data pieces which have been subjected to the gamma correction are stored as “011”. FIG. 5E shows that part of the image data stored in memory 14 has been binarized at processing portion 12. The state flag regions of the pixel data pieces which have been binarized are stored as “110”. FIG. 5F shows that all the pixel data pieces in the image data stored in memory 14 have been binarized at processing portion 12. The state flag regions of all the pieces of the pixel data are stored as “110”.

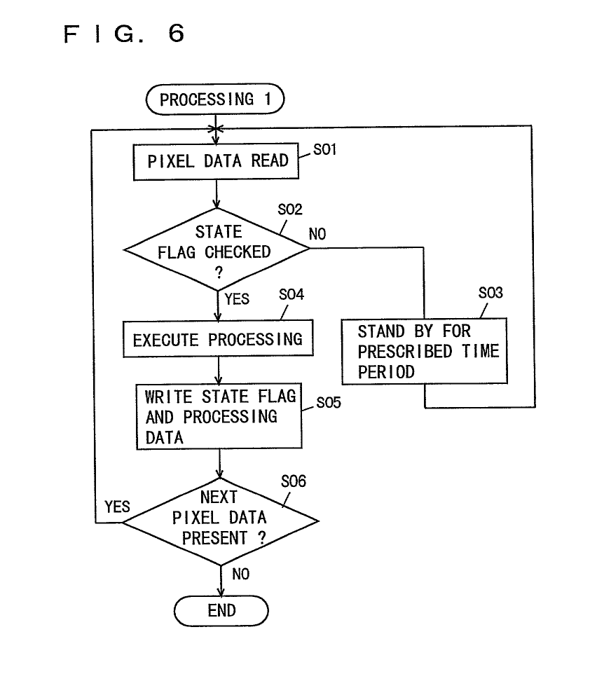

The flow of process performed through processing portions 9 to 12 will be now described. When image data is read by image input device 8, the pixel data pieces are stored in memory 14 in the order in which they have been read. Referring to FIG. 6, processing portions 9 to 12 read the pixel data pieces stored in memory 14 in the order in which they have been read at image input device 8 (step S01). The state flag of the read pixel data is checked (step S02). The checking of the state flag is performed to determine whether the read pixel data can be processed. For example, referring to FIG. 3, in Log conversion, if the state flag is “000”, the data can be processed, and otherwise the data cannot be subjected to Log conversion. Similarly, MTF correction can be performed only if the state flag is “001”, gamma correction can be performed only if the state flag is “010”, and binarization can be performed only if the state flag is “011”.

If read pixel data cannot be processed (NO in step S02), after standing by for a prescribed time period (step S03), pixel data is once again read (step S01). This is because the order of processings to one piece of pixel data is prescribed and pixel data is processed in the order the data has been read by image input device 8. As a result, if the data is determined to be unable to be processed based on the result of checking the state flag in step S02, this means that the pixel data has not been subjected to processing in the preceding stage. For example, when processing portion 11 which performs gamma correction checks the state flag by reading pixel data, the state flag representing the data unable to be processed is “000” or “001”. In this case, pixel data needs only be read after the preceding processing has been completed. The prescribed time period in step S03 needs only be the time period necessary for such preceding processing.

If the processing is determined possible by the checking of the state flag (YES in step S02), the processing is executed (step S04). After the processing, the processed data and state flag are written into memory 14 (step S05). Referring to FIG. 3, the state flag written here is “001” if the process executed in step S04 is Log conversion, “010” for MTF conversion, “011” for gamma correction and “110” for binarization.

Then, the presence/absence of pixel data to be processed is determined (step S06), and if the pixel data to be processed is present, the control proceeds to step S01, and the above process is repeated, and if there is no pixel data to be processed, the processing ends.

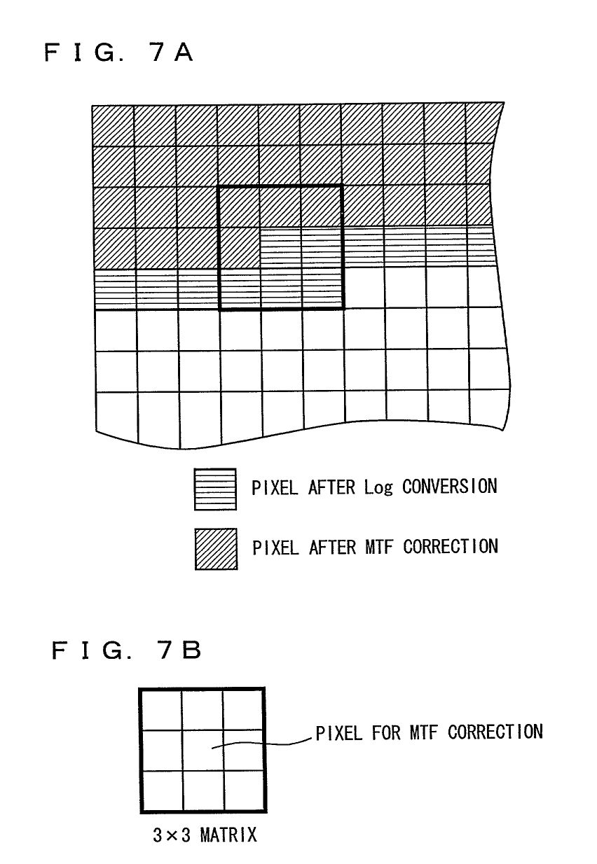

In step S02 in FIG. 6, it is determined if the read pixel data is to be processed based on the result of checking the state flag, while if the processing to be performed to the pixel data is MTF correction, the following processing is performed in addition to the checking of the flag. Referring to FIG. 7A, the MTF correction is performed using the values of peripheral pixels of the pixel to be processed. Therefore, the pixels following the pixel to be processed might not have gone through the preceding stage processing, Log conversion. For example if a matrix of 3×3 is used for MTF correction as shown in FIG. 7B, all the pixels in the matrix of 3×3 having the pixel to be processed in the center must go through Log conversion beforehand. As a result, it is determined in step S02 in FIG. 6 for the MTF conversion whether or not the state flag of the pixel to be processed as well as all the other state flags of the pixels included in the 3×3 matrix are “001”. Therefore, in step S01 in FIG. 6, nine pieces of pixel data included in the 3×3 matrix shown in FIG. 7 will be read.

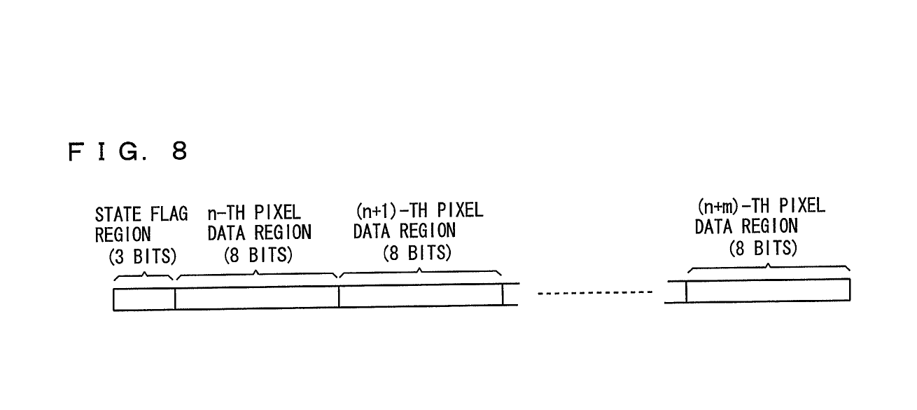

In this embodiment image data is stored in memory 14 in the format having the state flag region and data region for each pixel data piece (see FIG. 2), but one state flag may be provided for a plurality of pieces of pixel data, and a format having one state flag region and a plurality of data regions may be employed. FIG. 8 shows an example of such a format having one state flag region and a plurality of data regions. The format shown in FIG. 8 is effective for example if one state flag is provided for one line of pixel data pieces, or the image data is divided into 3×3 or 5×5 matrices and the pixel data included in each matrix is provided with one flag. If the format shown in FIG. 8 is used, processing portions 9 to 12 each read pixel data for each of the format shown in FIG. 8 for executing processing.

Thus, if one state flag is provided for a plurality of pieces of pixel data, the memory capacity of memory 14 can be reduced.

As in the foregoing, the data processing apparatus according to the embodiment uses one common memory for a plurality of processing portions, and a state flag is stored in association with pixel data stored in the common memory, the memory capacity can be reduced. Furthermore, in each of the processing portions, a state flag in association with pixel data can be checked to determine whether or not the pixel data can be processed, processings can be executed in an asynchronous manner without synchronization among the processing portions, so that the asynchronous processing can be more readily controlled.

Second Embodiment

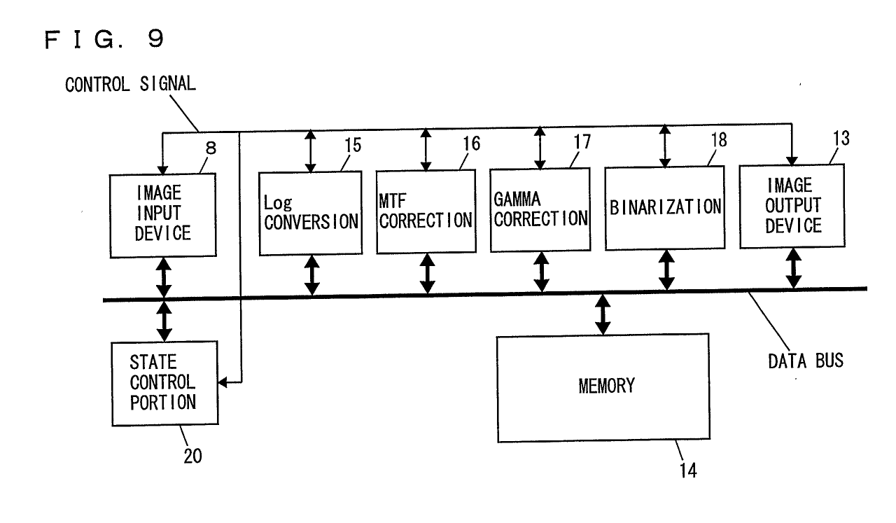

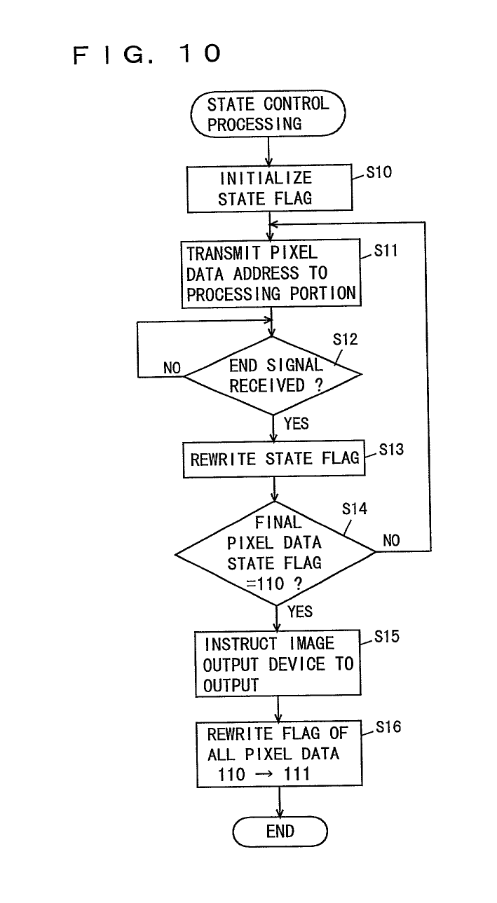

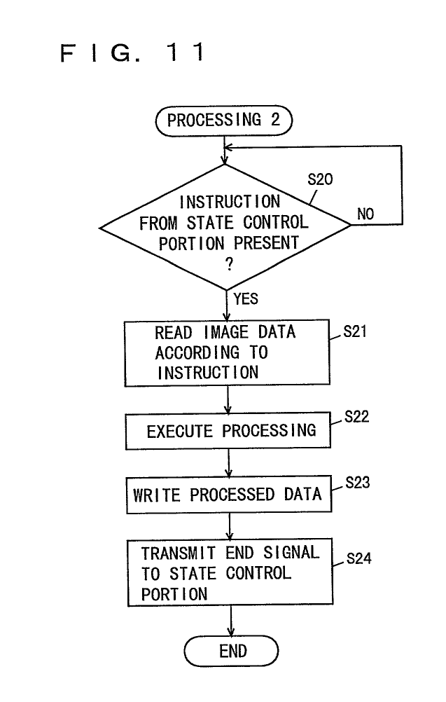

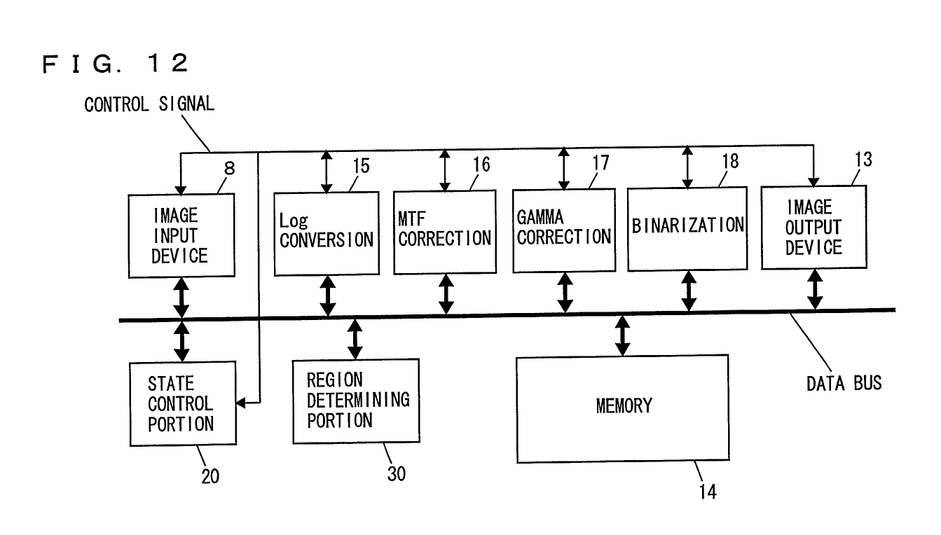

Referring to FIG. 9, a data processing apparatus according to a second embodiment of the invention includes a state control portion 20 in addition to the construction according to the first embodiment. State control portion 20 is connected to an image input device 8, processing portions 15 to 18, and an image output device 13, and controls these elements. Other than the processings by state control portion 20 and processing portions 15 to 18, the data processing apparatus according to the second embodiment is the same as the data processing apparatus according to the first embodiment, and the description is not repeated here.

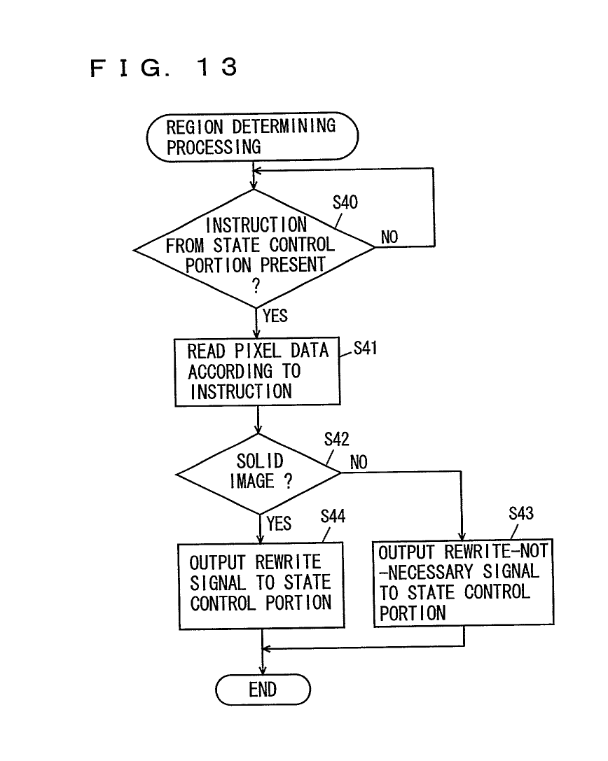

Referring to FIG. 10, state control portion 20 rewrites the state flag region of memory 14 into “000” to initialize the state flag (step S10). Then, state control portion 20 constantly monitors the state of memory 14 described in conjunction with FIG. 5, and transmit to processing portions 15 to 18 the address of pixel data to be processed (step S11). Processing portions 15 to 18 access memory 14 based on the address received from state control portion 20 to read pixel data and perform respective processings. When processing has been completed at any of processing portions 15 to 18, an end signal is transmitted to state control portion 20. State control portion 20 is in a stand-by state until the end signal from processing portions 15 to 18 is received (step S12), and once the end signal is received from any of processing portions 15 to 18, the state flag region corresponding to the pixel data processed by the processing portion which has transmitted the end signal is rewritten (step S13). Assume for example that the address An of pixel data n has been transmitted to processing portion 16 performing MTF correction. If the end signal is received from processing portion 16 in step S12, the state flag region of memory 14 in which pixel data n is stored is rewritten into “010” in step S13.

It is then determined if the final pixel data, in other words, the data which has been read in the end by image input device 8 has the flag “110”, and if the flag is “110”, the control proceeds to step S15. The control otherwise proceeds to step S11 and the process from steps S11 to S13 is repeated.

The state flag of the final pixel data having “110” means that all the pieces of pixel data have been binarized, in other words that all the processings have completed.

In step S15, an instruction to output image data stored in memory 14 is provided to image output device 13. Once image data stored in memory 14 has been printed and output by image output device 13, the flag regions of all the pieces of pixel data stored in memory 14 are rewritten from “110” into “111” (step S16). Then, the process is completed.

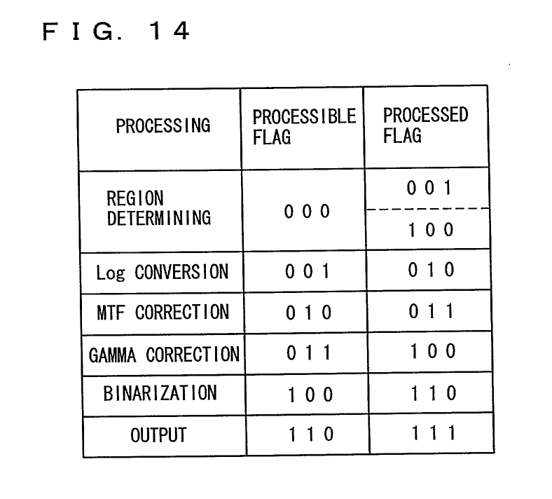

Referring to FIG. 11, processing portions 15 to 18 wait for an instruction from state control portion 20 (step S20). The instruction from state control portion refers to transmission of the address of pixel data to be transmitted from state control portion 20 in step S11 in the state control processing shown in FIG. 10. When the address from state control portion 20 is received, the address in memory 14 is accessed and image data is read (step S21), and the processing is executed (step S22). The processing herein refers to Log conversion, MTF correction, gamma correction or binarization.

Once the processing to the read image data has been completed, the processed data is written in memory 14. The address to which the data is written at this time is the address received from state control portion 20 in step S20. Once the writing to memory 14 is completed, an end signal is transmitted to state control portion 20 (step S24).

Thus, the data processing apparatus according to the second embodiment controls processing portions 15 to 18 as it monitors the progress in processing portions 15 to 18 by state control portion 20, so that processing portions 15 to 18 can be operated asynchronously, i.e., without synchronization.

Third Embodiment

Referring to FIG. 12, a data processing apparatus according to a third embodiment of the invention includes a region determining portion 30 in addition to the data processing apparatus according to the second embodiment. The other construction is the same as that of the data processing apparatus according to the second embodiment, and therefore the description is not repeated here.

Region determining portion 30 determines whether or not pixel data input at image input device 8 is pixel data of solid image before Log conversion by processing portion 15.

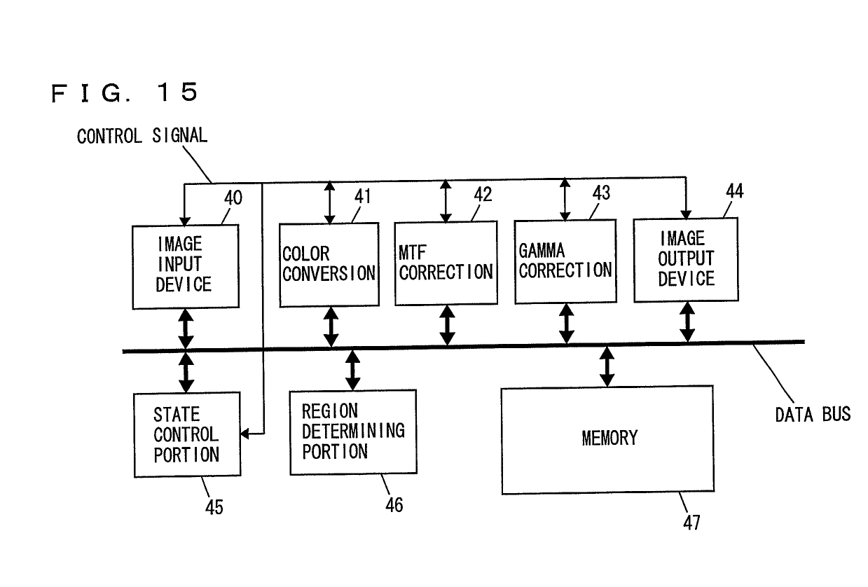

The region determining process performed at region determining portion 30 will be now described. Referring to FIG. 13, the region determining process is in a stand-by state until there is an instruction from state control portion 20 (step S40). The instruction from state control portion 20 herein refers to the reception of the address of pixel data output by state control portion 20 in step S11 in the state control processing in FIG. 10. Once the address of image data is received from state control portion 20 (YES in step S40), a pixel data piece corresponding to the received address and pixel data pieces around that pixel data piece, for example the pixel data pieces included in a 3×3 matrix having in the center the pixel data piece corresponding to the received address is read from memory 14 (step S41).

It is then determined if the 3×3 matrix region is a solid image based on the pixel image data (step S42). The solid image refers to the image in which all the pixel data included in the 3×3 matrix take the same value since image data input by image input device 8 is monochrome according to this embodiment. Note that if the image data input by image input device 8 is color data, the solid image refers to image data in which the chroma and brightness of the image data included in the 3×3 matrix both take the same value.

If it is determined in step S42 that the data is solid image data, a rewriting signal is output to state control portion 20 (step S44). If it is determined that the data is not solid image data (NO in step S42), a rewrite-not-necessary signal is output to state control portion 20 (step S43). Then this processing is completed.

State control portion 20 performs state control processing shown in FIG. 10, and a rewrite signal or rewrite-not-necessary signal is received from region determining portion 30 rather than an end signal. If a rewrite signal is received, the state flag is rewritten into “110” in step S13. If a rewrite-not-necessary signal is received in step S12, the state flag is rewritten into “001” in step S13.

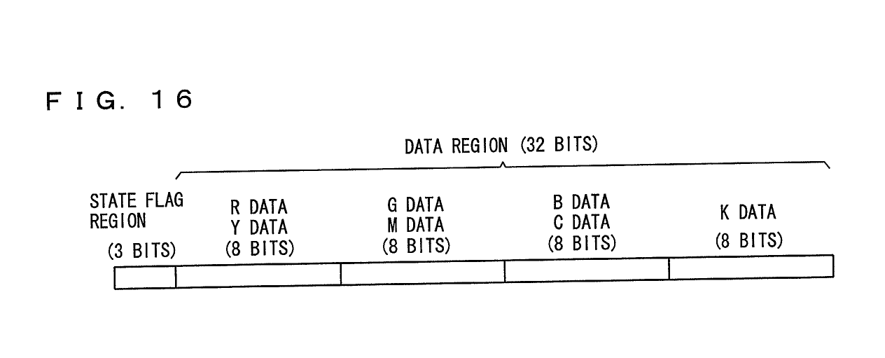

Referring to FIG. 14, in the region determining processing, if the data is determined to be solid image data, the state flag is rewritten into “110”. The image data having the state flag rewritten into “110” is then subjected to binarizing.

As described above, the data processing apparatus according to the third embodiment determines if pixel data is solid image data by region determining portion 30. If the pixel data is solid image data, three processings, Log conversion, MTF correction, and gamma correction are not performed, in other words the intermediate process can be omitted so that the data processing can be performed at a higher speed.

Fourth Embodiment

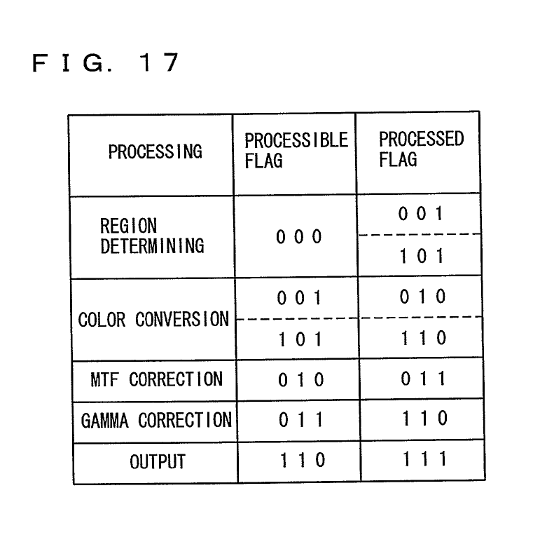

Referring to FIG. 15, a data processing apparatus according to a fourth embodiment of the invention can handle color data while the data processing apparatus according to the third embodiment handles monochrome data. The data processing apparatus according to the fourth embodiment includes an image input device 40 which can input a color image, an image output device 44 which can output a color image, processing portions 41 to 43 for performing three processings, color conversion, MTF correction and gamma correction, a state control portion 45, a region determining portion 46, and a memory 47.

Image input device 40 stores in memory 47 image data read by a photoelectric conversion element such as CCDs. The image data consists of three data pieces, i.e., R (red), G (green), and B (blue) data for one pixel. By the color conversion processing at processing portion 41, the three pieces of data R, G, and B are converted into four pieces of data Y (yellow), M (magenta), C (cyan), K (black). As a result, image data after color conversion consists of 4 kinds of data, Y, M, C and K for one pixel, and therefore amounts to four times as much as monochrome data.

A format of image data stored in memory 47 according to the fourth embodiment will be now described. Referring to FIG. 16, image data handled by the data processing apparatus according to the fourth embodiment includes three kinds of data, R, G and B or four kinds of data Y, M, C and K for one pixel. The data format therefore consists of one 3-bit state flag region and four 8-bit data regions for one pixel. As a result, the pixel data for one pixel is stored in total by 35 bits including the 3-bit state flag region and the 32-bit data region. The pixel data input at image input device 40 has its state flag “000” stored in the state flag region, its R data stored in the first 8 bits of the data region, its G data stored in the next 8 bits of the data region and its B data stored in the next 8 bits of the data region. After color conversion at processing portion 41, state flag “010” is stored in the state flag region and Y data is stored in the first 8 bits of the data region, M data in the next 8 bits, C data in the next 8 bits and K data in the next 8 bits.

State control portion 45, processing portions 41 to 43, region determining portion 46 handle color data unlike state control portion 20, processing portions 9 to 12 and region determining portion 30 according to the third embodiment which handles monochrome data. The other construction is the same as the data processing apparatus according to the third embodiment and therefore the description is not repeated.

Region determining portion 46 determines whether pixel data is included in the region of a solid image. The process shown in FIG. 13 described in connection with the region determining process of region determining portion 30 may be employed for this process. Note, however, that in step S42, it is determined whether the image is a solid image based on if the chroma and brightness of the pixel data included in the range of a 3×3 matrix are all the same. If the chroma and brightness are the same, the image is determined to be a solid image, and otherwise the image is determined as a non-solid image. The chroma and brightness are calculated using the three pieces of data, R, G and B of the pixel data included in the matrix of 3×3.

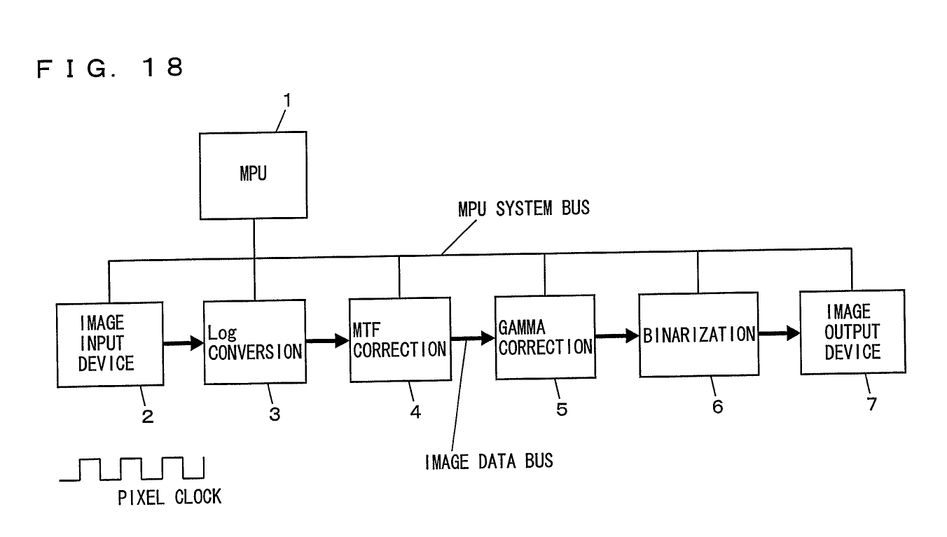

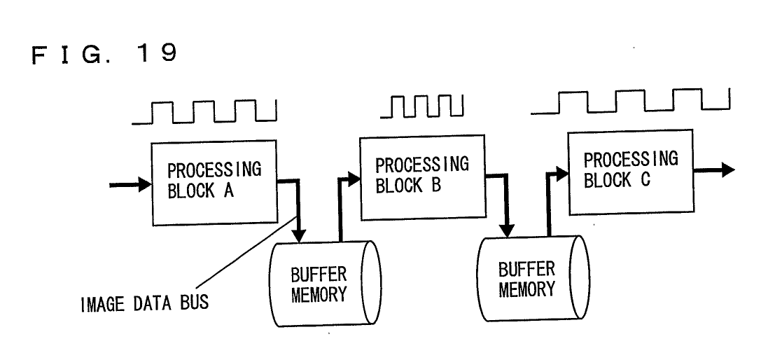

The state flag of the data processing apparatus according to the fourth embodiment will be now described. Referring to FIG. 17, if region determining portion 46 determines that pixel data is solid image data, the state flag is rewritten into “110” and otherwise rewritten into “001”.

In processing portion 41 to execute color conversion processing, pixel data having a state flag of “001” or “100” is subjected to color conversion. As for pixel data having a state flag of “001”, the state flag is rewritten into “010”, and as for pixel data having a state flag of “100”, the state flag is rewritten into “110” after the completion of the color conversion.

Therefore, if the pixel data is solid image data, the two processings, MTF correction and gamma correction will not be performed.

As described above, the data processing apparatus according to the fourth embodiment provides and stores one state flag for each piece of pixel data for color data, and the pixel data stored in the memory is processed by a plurality of processing portions. As a result, the capacity of memory can be reduced if color images are handled. Furthermore, when pixel data is solid image data, MTF correction and gamma correction are not performed, and therefore the data processing speed can be improved if the image data is color data.

It is understood that the construction according to the fourth embodiment removed of region determining portion 46 or removed of state control portion 45 and region determining portion 46 may be employed.

In addition, while according to the fourth embodiment, in the format of pixel data, one state flag is provided for one piece of pixel data, one state flag may be provided for a plurality of pieces of pixel data. For example, one state flag may be provided for pixel data for one line, or image data may be divided into 3×3 matrices, and one state flag may be provided for pixel data included in the range of each 3×3 matrix.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data processing system comprising:
a plurality of processors for executing a series of processings to data to be processed in a prescribed order; and
a memory for storing said data to be processed and state information to represent the processing state of said data in association with each other,
wherein
processings executed by said plurality of processors are asynchronously executed and said plurality of processors share said memory.

2. The data processing system according to claim 1, wherein
said plurality of processors each determine if said data to be processed can be processed based on said state information.

3. The data processing system according to claim 2, wherein
said plurality of processors each execute a processing to said data to be processed, and then rewrite said state information corresponding to the processed data.

4. The data processing system according to claim 1, further comprising a first controller for controlling said plurality of processors to execute said series of processings based on said state information.

5. The data processing system according to claim 4, wherein
said first controller rewrites said state information corresponding to processed data in response to the completion of each of processings by said plurality of processors.

6. The data processing system according to claim 1, further comprising a second controller for determining the attribute of said data to be processed, wherein
said second controller rewrites said state information corresponding to said data to be processed in order to change the order of executing said series of processings if it is determined that said data to be processed has a prescribed attribute.

7. The data processing system according to claim 6, wherein
said second controller rewrites said state information corresponding to said data to be processed in order to remove a part of said series of processings, if it is determined that said data to be processed has a prescribed attribute.

8. The data processing system according to claim 1, wherein
said memory has one region to store said state information corresponding to one region to store said data to be processed.

9. The data processing system according to claim 1, wherein
said memory has one region to store said state information corresponding to a plurality of regions to store said data to be processed.

10. The data processing system according to claim 1, wherein
said data to be processed is image data.

11. A data processing system, comprising:
a plurality of processing means for executing a series of processings to data to be processed in a prescribed order; and
memory means for storing said data to be processed and state information to represent the processing state of said data in association with each other, wherein
processings executed by said plurality of processing means are executed asynchronously, and said plurality of processing means share said memory means.

12. The data processing system according to claim 11, wherein
said plurality of processing means each determine whether said data to be processed can be processed based on said state information.

13. The data processing system according to claim 12, wherein
said plurality of processing means each execute a processing to said data to be processed and then rewrite said state information corresponding to the processed data.

14. The data processing system according to claim 11, further comprising first control means for controlling said plurality of processing means to execute said series of processings based on said state information.

15. The data processing system according to claim 14, wherein
said first control means rewrites said state information corresponding to processed data in response to the completion of each of processings by said plurality of processing means.

16. The data processing system according to claim 11, further comprising a second control means for determining the attribute of said data to be processed, wherein
if it is determined that said data to be processed has a prescribed attribute, said second control means rewrites said state information corresponding to said data to be processed in order to change the order of executing said series of processings.

17. The data processing system according to claim 16, wherein
said second control means rewrites said state information corresponding to said data to be processed in order to remove a part of said series of processings if it is determined that said data to be processed has a prescribed attribute.

18. The data processing system according to claim 11 wherein
said memory means has one region to store said state information corresponding to one region to store said data to be processed.

19. The data processing system according to claim 11, wherein
said memory means has one region to store said state information corresponding to a plurality of regions to store said data to be processed.

20. The data processing system according to claim 11, wherein
said data to be processed is image data.
